(19) United States
(12) Patent Application Publication
(10) Pub. No.: US 2008/0095458 A1
(43) Pub. Date: Apr. 24, 2008

(54) METHOD AND APPARATUS FOR GENERATING OUTPHASED SIGNALS

(75) Inventors: Magdi A. Mohamed, Schaumburg, IL (US); Amir S. Ibrahim, Hoffman Estates, IL (US); Weimin Xiao, Hoffman Estates, IL (US)

Correspondence Address: Mr. Ronald E. Prass, Jr.,;Irving, Prass & Stelacone, LLP, Suite 205, 1419 Forest Drive, Annapolis, MD, 21403, US

(73) Assignee: Motorola, Inc., Schaumburg, IL (US)

(21) Appl. No.: 11/551,046

(22) Filed: Oct. 19, 2006

(51) Int. Cl. G06K 9/40

(52) U.S. Cl. 382/260

(57) ABSTRACT

A method, apparatus, and electronic device for generating outphased signals are disclosed. The method may include determining bitmap representations of two binary circles, storing the bitmap representations of the two binary circles, generating two constant-amplitude signals from an original signal using bitmap overlapping of the stored bitmap representations where the vector sum of the two constant-amplitude signals equals the original signal, and outputting the two constant-amplitude signals for use in an electronic device.

### BACKGROUND OF THE INVENTION

1. Field of the Invention

The present invention relates to digital signal processing for electronic devices, and in particular, a method and system for generating outphased signals.

2. Introduction

In existing communications systems, electronic components, such as power amplifiers are subject to non-linearities that add noise and cause significant signal distortion. In particular, conventional amplifiers become quickly and significantly non-linear at relatively low output and this often forces designers to trade-off efficiency for linearity.

Attempts have been made to combat this problem by outphasing the signals during processing using digital techniques. Outphased signals are constant-amplitude signals with a variable phase. However, conventional techniques to generate and utilize outphased signals require complex function calculations or large look up tables to store required variables.

### SUMMARY OF THE INVENTION

A method, apparatus, and electronic device for generating outphased signals are disclosed. The method may include determining bitmap representations of two binary circles, storing the bitmap representations of the two binary circles, generating two constant-amplitude signals from an original signal using bitmap overlapping of the stored bitmap representations where the vector sum of the two constant-amplitude signals equals the original signal, and outputting the two constant-amplitude signals for use in an electronic device.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary diagram of outphasing signal processing system in accordance with a possible embodiment of the invention;

FIG. 2 is an exemplary diagram of a signal that has been decomposed into two individually amplitude-controlled signals in accordance with a possible embodiment of the invention;

FIGS. 3A-3D are exemplary illustrations of shifting and overlapping of a signal that has been decomposed into two individually amplitude-controlled signals in accordance with a possible embodiment of the invention;

FIG. 4 is an exemplary flowchart illustrating one possible process for determining the overlapped region between the two binary circles in accordance with one possible embodiment of the invention;

FIG. 5 illustrates an exemplary block diagram of a possible processing device for implementing the outphased signal creation process in accordance with a possible embodiment of the invention;

FIG. 6 is an exemplary flowchart illustrating one possible outphased signal creation process in accordance with one possible embodiment of the invention;

FIG. 7 is an exemplary flowchart illustrating one possible outphased signal creation process using non-encoded bitmaps in accordance with one possible embodiment of the invention;

FIGS. 8A-8E illustrate exemplary diagrams of the resultant bitmap images at various stages of the possible outphased signal creation process in FIG. 7 in accordance with one possible embodiment of the invention;

FIG. 9 illustrates an exemplary non-encoded bitmap image and its encoded bitmap data structure in accordance with one possible embodiment of the invention;

FIG. 10 illustrates an exemplary flowchart illustrating one possible outphased signal creation process using encoded bitmaps in accordance with one possible embodiment of the invention;

FIGS. 11A-11D illustrate exemplary diagrams of the encoded bitmap data structure of the resultant images at various stages of the possible outphased signal creation process in FIG. 10 in accordance with one possible embodiment of the invention;

FIG. 12 is an exemplary flowchart illustrating the shift right operation for one possible outphased signal creation process using encoded bitmaps in accordance with one possible embodiment of the invention;

FIG. 13 is an exemplary flowchart illustrating the shift left operation for one possible outphased signal creation process using encoded bitmaps in accordance with one possible embodiment of the invention;

FIG. 14 is an exemplary flowchart illustrating the shift up operation for one possible outphased signal creation process using encoded bitmaps in accordance with one possible embodiment of the invention;

FIG. 15 is an exemplary flowchart illustrating the shift down operation for one possible outphased signal creation process using encoded bitmaps in accordance with one possible embodiment of the invention; and

FIG. 16 is an exemplary flowchart illustrating the “and” operation for one possible outphased signal creation process using encoded bitmaps in accordance with one possible embodiment of the invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a system, method, computer-readable medium, and other embodiments that relate to the basic concepts of the invention.

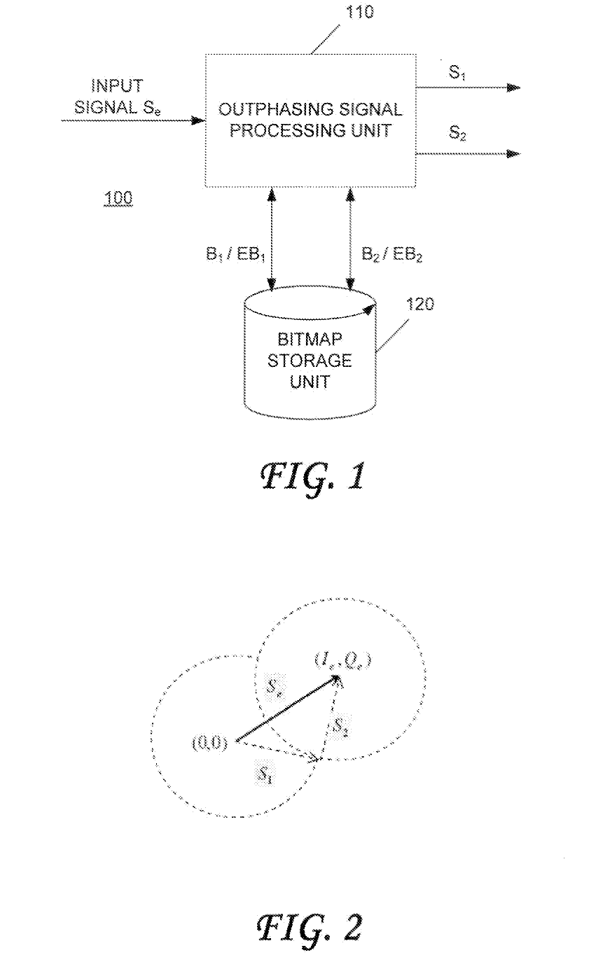

FIG. 1 illustrates an exemplary diagram of an outphasing signal processing system 100 in accordance with a possible embodiment of the invention. In particular, the outphasing signal processing system 100 may include an outphasing signal processing unit 110 and bitmap storage unit 120. As shown in the drawing, the outphasing signal processing unit 110 receives an input signal Sₑ and generates two constant-amplitude signals S₁ and S₂ from the input signal Sₑ in accordance with the processes described in detail below. The outphasing signal processing unit 110 may store, at least temporarily, the two bitmap data structures B₁ and B₂ and/or encoded bitmap data structures EB₁ and EB₂ in the bitmap storage unit 120. The outphasing signal processing unit 110 may then recall any of the data structures B₁ , B₂, EB₁ or EB₂ from the bitmap storage unit 120 and after processing them, may forward the resultant outphased signals S₁, and S₂ to another electronic device, such as a power amplifier, for example, for further processing. However, as one of skill in the art may appreciate, the outphasing signal processing unit 110 may also be a component of an electronic device, such as a power amplifier, for or contained in, a communication device such as a cellular phone.

FIG. 2 is an exemplary diagram of illustrating the concept of outphasing signals in accordance with possible embodiments of the invention. As shown, signal Sₑ is represented by a vector from (0, 0) to (Iₑ, Qₑ). Using two dashed-line circles of equal and fixed radius values, the intersection of those circles will provide a point of intersection where two vectors of constant-amplitude S₁ and S₂ meet. The vector sum of S₁ and S₂ will always equal the original signal Sₑ.

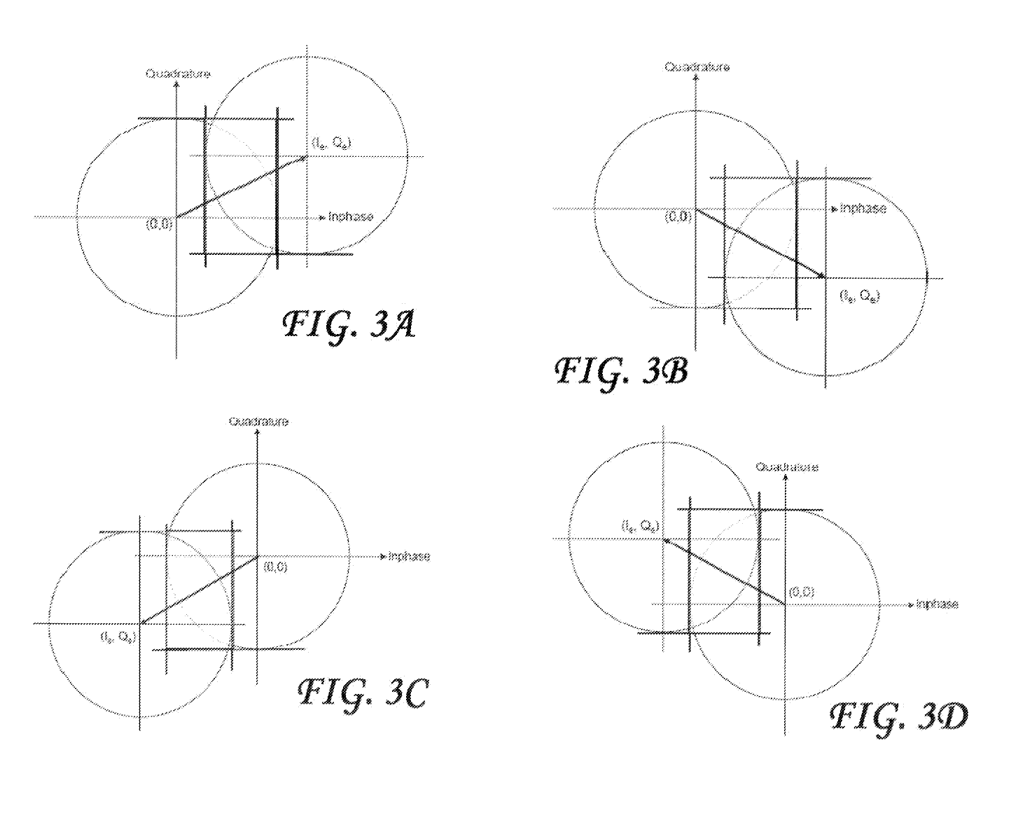

FIGS. 3A-3D are exemplary illustrations of shifting and overlapping of a signal that has been decomposed into two individually amplitude-controlled signals such as those shown in FIG.2 in accordance with a possible embodiment of the invention. FIG. 3A shows the overlapping portion between the two circles when the vector components of signal Sₑ (Iₑ, Qₑ) result in Iₑ>0 and Qₑ>0. FIG. 3B shows the overlapping portion between the two circles when the vector components of signal Sₑ (Iₑ, Qₑ) result in Iₑ>0 and Qₑ<0. FIG. 3C shows the overlapping portion between the two circles when the vector components of signal Sₑ (Iₑ, Qₑ) result in Iₑ<0 and Q, <0. FIG. 3D shows the overlapping portion between the two circles when the vector components of signal Sₑ (Iₑ, Qₑ) result in Iₑ0 and Qₑ>0.

In FIG. 3A, assuming that the radius values of the two circles, B₁ and B₂, are set to R₁=1/2, R₂=1/2, respectively, and the input signal values Iₑ and Qₑ are given in the range of [−1, 1] and the amplitude Rₑ=\sqrt{Iₑ²+Qₑ²} of the input signal (Iₑ, Qₑ) is less than or equal to 1 (Rₑ<=1); the overlap region between the two circles is therefore from the upper-left corner point (1ₑ−1/2, 1/2) to the lower-right corner point (1/2, Qₑ−1/2). The height of the overlap region is (1−Qₑ), and the width of the overlap region is (1−Iₑ).

Using bitmap representation of the circles, and assuming that the input signal values I and Q are now in the range of [−N, N], the total number of rows or columns of each circle bitmap is (N+1). When the input condition (I>0 and Q>0) is true, the corresponding overlap region, from the upper-left corner to the lower-right corner will be from point (I-N/2, N/2) to point (N/2, Q-N/2), and the total number of rows in the overlap region is (N-Q). The height of the overlap region, i.e., the number of overlapping rows, is (N-Q), and the width of the region, i.e., the number of overlapping columns, is (N-I). For the other input conditions, namely, (I>0 and Q<0), or (I<0 and Q>0), or (I<0, Q<0), similar procedure can be used to determine the corresponding values of start_row, end_row, start_column, and end_column of the overlap region between the two bitmaps as illustrated in FIG. 3B, FIG. 3C, FIG. 3D respectively.

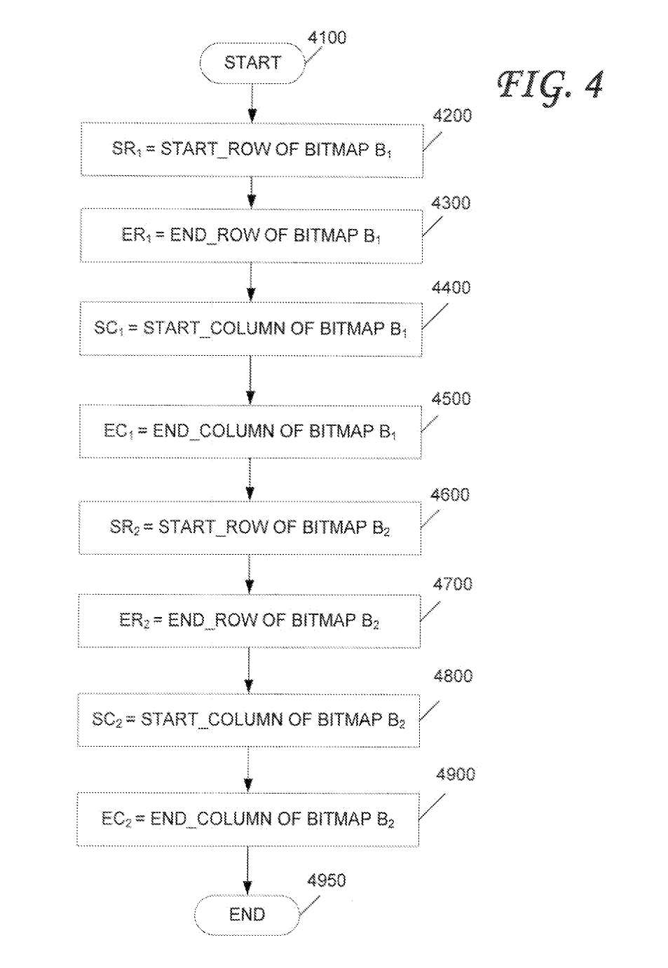

FIG. 4 is an exemplary flowchart illustrating one possible process for determining the overlapped region between the two binary circles in accordance with one possible embodiment of the invention. The process begins at step 4100 and continues to step 4200 where the value of SR₁ is set to equal the start_row value of bitmap B₁. At step 4300, the value of ER₁ is set to equal the end_row value of bitmap B₁. At step 4400, the value of SC₁ is set to equal the start_column value of bitmap B₁. At step 4500, the value of EC₁ is set to equal the end_column value of bitmap B₁.

At step 4600, the value of SR₂ is set to equal the start-row value of bitmap B₂. At step 4700, the value of ER₂ is set to equal the end_row value of bitmap B₂. At step 4800, the value of SC₂ is set to equal the start_column value of bitmap B₂. At step 4900, the value of EC₂ is set to equal the end_column value of bitmap B₂. The process goes to step 4950 and ends.

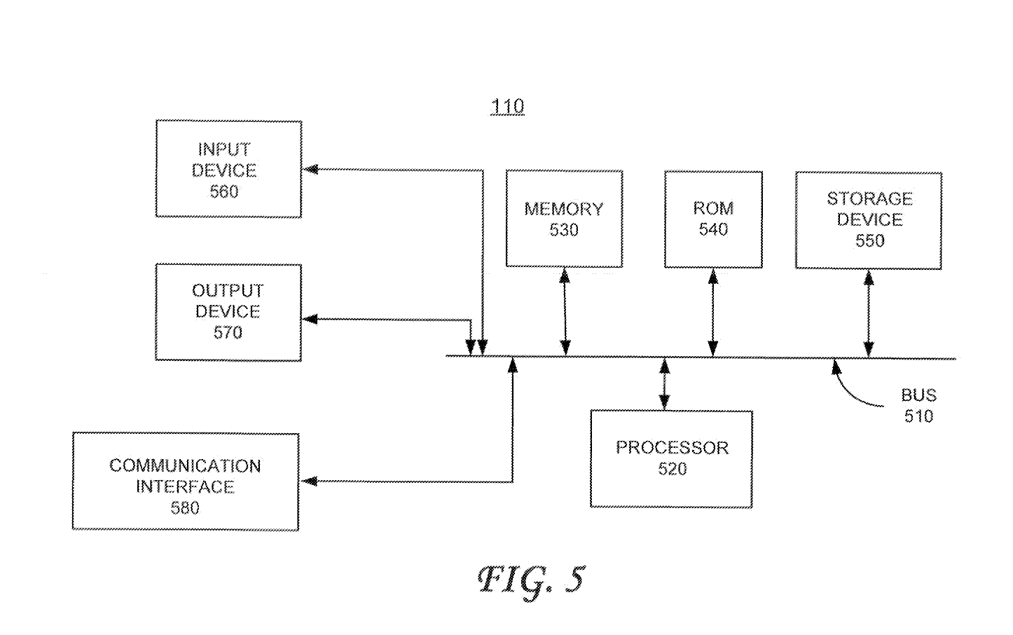

FIG. 5 illustrates an exemplary outphasing signal processing unit 110, or device which may implement one or more modules or functions of the outphasing signal creation process shown below in FIGS. 5-16. Thus, the exemplary outphasing signal processing unit 110 may include a bus 510, a processor 520, a memory 530, a read only memory (ROM 540, a storage device 550, an input device 560, an output device 570, and a communication interface 580. Bus 510 may permit communication among the components of the outphasing signal processing system 100.

Processor 520 may include at least one conventional processor or microprocessor that interprets and executes instructions. Memory 530 may be a random access memory (RAM) or another type of dynamic storage device that stores information and instructions for execution by processor 520. Memory 530 may also store temporary variables or other intermediate information used during execution of instructions by processor 520. ROM 540 may include a conventional ROM device or another type of static storage device that stores static information and instructions for processor 520. Storage device 550 may include any type of media, such as, for example, magnetic or optical recording media and its corresponding drive.

Input device 560 may include one or more conventional mechanisms that permit a user to input information to the outphasing signal processing unit 110, such as a keyboard, a mouse, a pen, a voice recognition device, etc. Output device 570 may include one or more conventional mechanisms that output information to the user, including a display, a printer, one or more speakers, or a medium, such as a memory, or a magnetic or optical disk and a corresponding disk drive. Communication interface 580 may include any transceiver-like mechanism that enables the outphasing signal processing unit 110 to communicate via a network. For example, communication interface 580 may include a modem, or an Ethernet interface for communicating via a Local Area Network LAN). Alternatively, communication interface 580 may include other mechanisms for communicating with other devices and/or systems via wired, wireless or optical connections. In some implementations of the outphasing signal processing system 100, communication interface 580 may not be included in the exemplary outphasing signal processing unit 110 when the outphasing signal creation process is implemented completely within the outphasing signal processing system 100.

The outphasing signal processing unit 110 may perform such functions in response to processor 520 by executing sequences of instructions contained in a computer-readable medium, such as, for example, memory 530, a magnetic disk, or an optical disk. Such instructions may be read into memory 530 from another computer-readable medium, such as storage device 550, or from a separate device via communication interface 580.

The outphasing signal processing system 100 illustrated in FIG. 1 and the related discussion are intended to provide a brief, general description of a suitable computing environment in which the invention may be implemented. Although not required, the invention will be described, at least in part, in the general context of computer-executable instructions, such as program modules, being executed by the outphasing signal processing unit 110, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network. In a distributed computing environment, program modules may be located in both local and remote memory storage devices.

For illustrative purposes, the outphasing signal creation process will be described below in relation to the block diagrams shown in FIGS. 1 and 5.

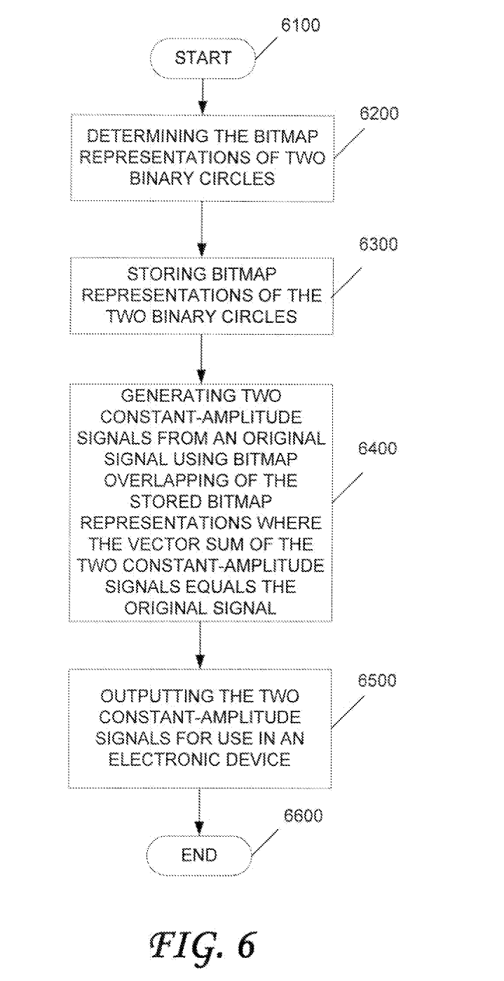

FIG. 6 is an exemplary flowchart illustrating steps associated with a possible outphasing signal creation process in accordance with a possible embodiment of the invention. The process begins at step 6100 and continues to step 6200 where the outphasing signal processing unit 110 determines the bitmap representations of two binary circles, such as those shown in FIG. 2. The bitmap representations may be encoded, or not encoded. At step 6300, the outphasing signal processing unit 110 stores the bitmap representations of the two binary circles in the bitmap storage unit 120. At step 6400, the outphasing signal processing unit 110 generates two constant amplitude signals with variable phases from an original input signal Sₑ using a bitmap overlapping technique. The vector sum of the phases of the two constant-amplitude signals will equal the original signal. At step 6500, the outphasing signal processing unit 110 outputs the two constant-amplitude signals for use in an electronic device, such as a power amplifier for a cellular telephone or mobile telephone, or any other electronic device known to one of skill in the art. The process goes to step 4400 and ends.

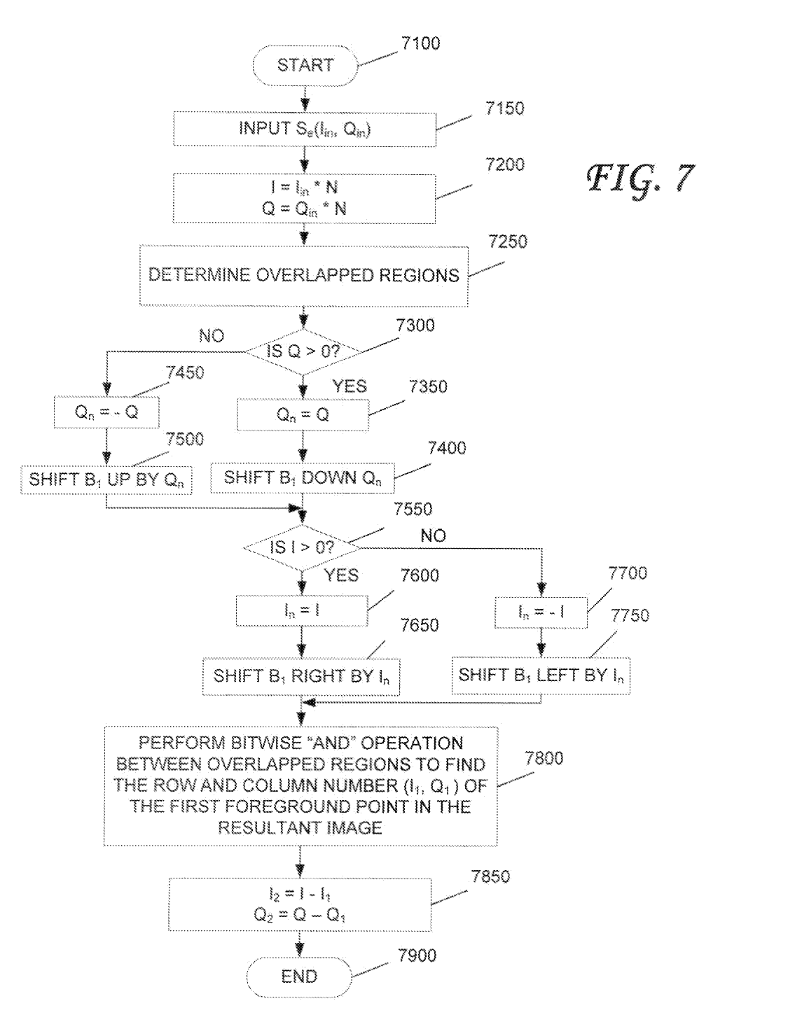

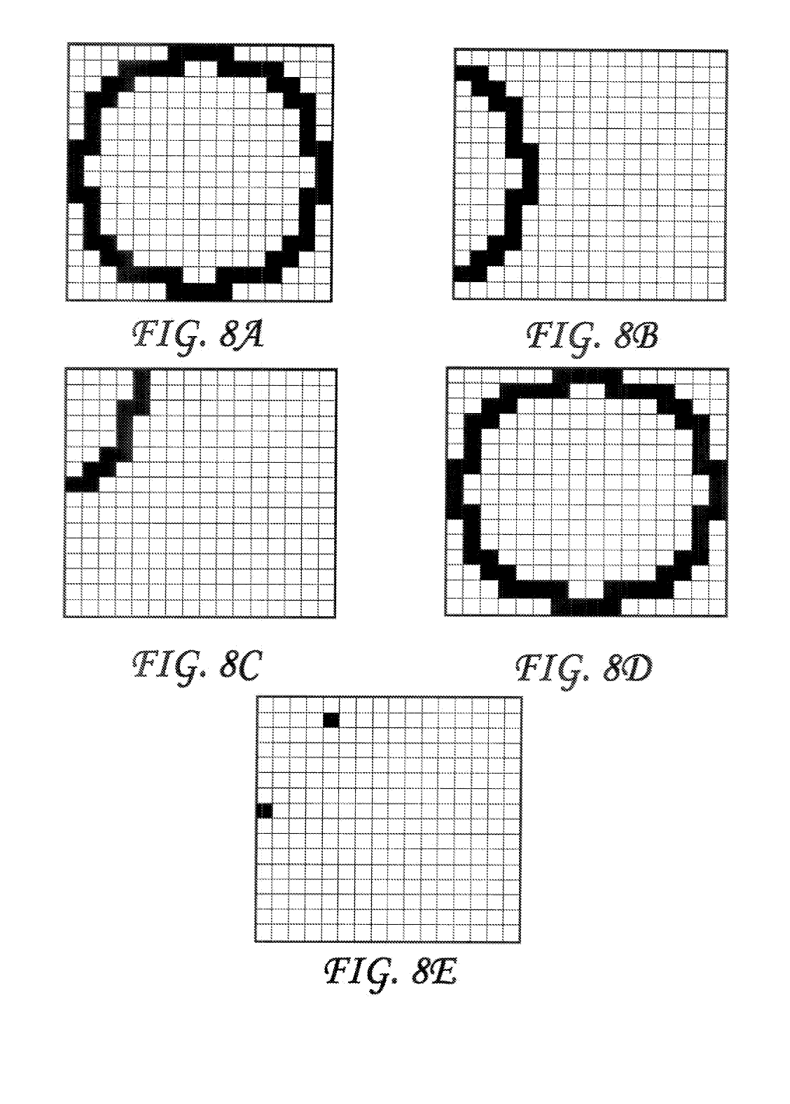

FIG. 7 is a flowchart illustrating the outphasing signal creation process using non-encoded bitmap images. The process begins at step 7100 and continues to step 7150, where signal Sₑ(Iᵢₙ, Qᵢₙ) is input to the outphasing signal processing unit 110. Iᵢₙ and Qᵢₙ are values between −1 and 1. The image B₁ representing the original bitmap is shown in FIG. 8A. At step 7200, the outphasing signal processing unit 110 multiplies the input signal Iᵢₙ and Qᵢₙ by the desired resolution N to determine the I and Q values.

At step 7250, the outphasing signal processing unit 110 determines the overlapped regions using a process known to one of skill in the art such as that shown in FIG. 4. At step 7300, the outphasing signal processing unit 110 determines whether Q is greater than zero. If Q is greater than zero, then at step 7350, the outphasing signal processing unit 110 sets Qₙ equal to Q. At step 7400, the outphasing signal processing unit 110 shifts the bitmap image B₁ down by Qₙ. If Q is not greater than zero, then at step 7450, the outphasing signal processing unit 110 sets Qₙ equal to −Q. At step 7500, the outphasing signal processing unit 110 shifts image B₁ up by Qₙ.

At step 7550, the outphasing signal processing unit 110 determines whether the value of I is greater than zero. If I is greater than zero, then at step 7600, the outphasing signal processing unit 110 sets Iₙ equal to 1. At step 7650, the outphasing signal processing unit 110 shifts the bitmap image B₁ right by Iₙ. If I is not greater than zero, then at step 7700, the outphasing signal processing unit 110 sets Iₙ equal to −I. At step 7750, the outphasing signal processing unit 110 shifts image B1 left by Iₙ. As an example, FIG. 8B shows the resulting bitmap image shifted left by 11 columns and FIG. 8C shows that image shifted up by 7 rows.

At step 7800, the outphasing signal processing unit 110 performs a bitwise AND operation between the overlapped regions of the binary circle B₁ shown in FIG. 8C, and the binary circle B₂ shown in FIG. 8D to find the row and column number (I₁, Q₁) of the foreground point in the resultant image. The resultant image is shown as the intersection points in FIG. 8E. At step 7850, the outphasing signal processing unit 110 determines values for S₂ (I₂, Q₂) where I₂ be equal to I-I₁ and Q₂ to be equal to Q-Q₁. The process goes to 7900, and ends.

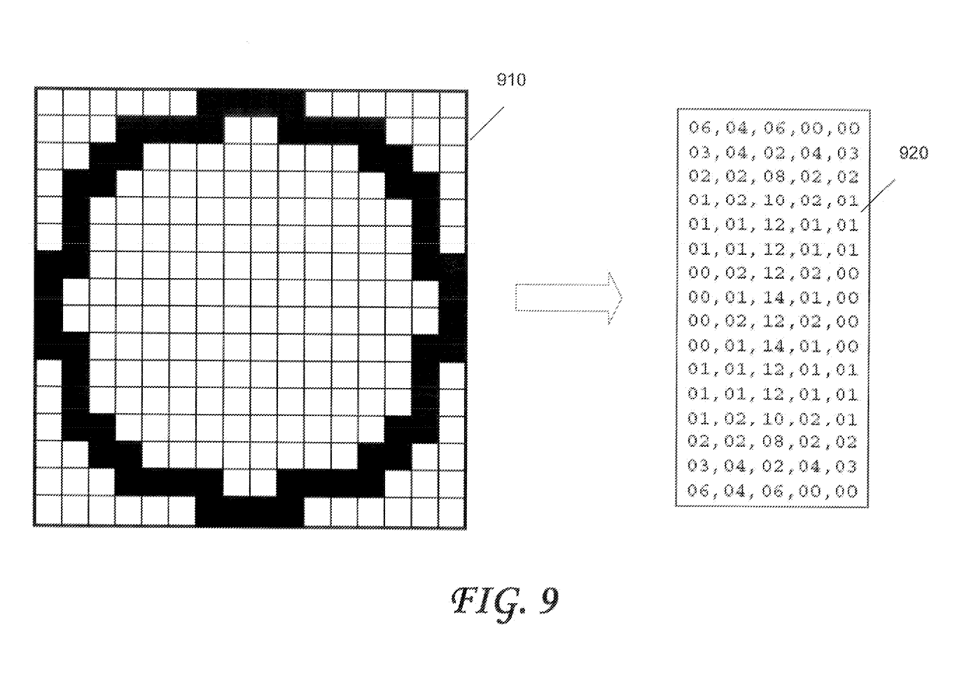

FIG. 9 illustrates a diagram of an exemplary bitmap image 910 and its corresponding data structure 920. The outphasing signal creation process illustrated in FIG. 7 may also utilize encoded bitmaps. The bitmaps are required to be 4-connected because 4-connectivity guarantees digital intersection of the two circles at least at one point in this case. In addition, even-symmetry ensures exactly the same accuracy for each I and Q component computation. Furthermore, each row and column is encoded separately, which simplifies the shifting operations.

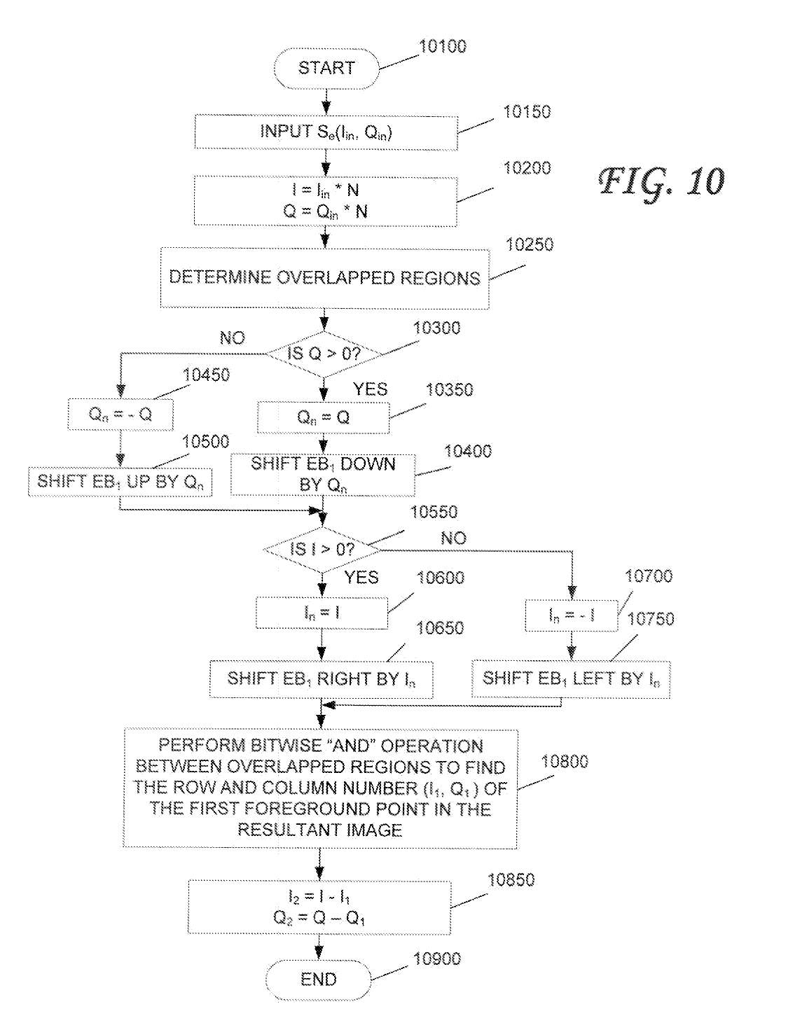

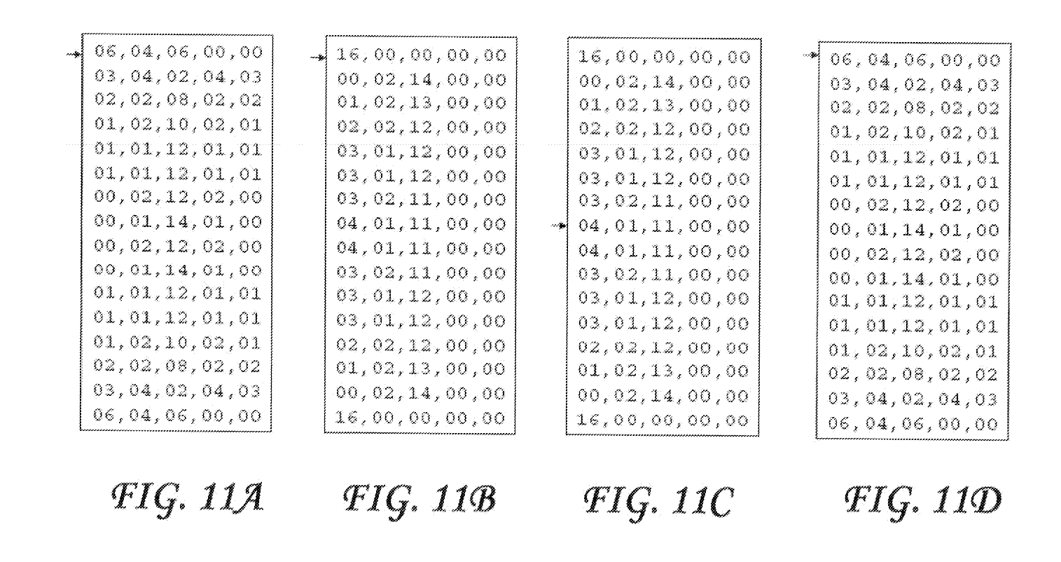

FIG. 10 is a flowchart illustrating the outphasing signal creation process using encoded bitmap images. The process begins at step 10100 and continues to step 10150, where signal Sₑ(Iᵢₙ, Qᵢₙ) is input to the outphasing signal processing unit 110. Iᵢₙ and Qᵢₙ are values between −1 and 1. The image B₁ representing the original data structure for the bitmap image is shown in FIG. 11A. At step 10200, the outphasing signal processing unit 110 multiplies the input signal Iᵢₙ and Qᵢₙ by the desired resolution N to determine the I and Q values.

At step 10250, the outphasing signal processing unit 110 determines the overlapped regions using a process known to one of skill in the art such as that shown in FIG. 4. At step 10300, the outphasing signal processing unit 110 determines whether Q is greater than zero. If Q is greater than zero, then at step 10350, the outphasing signal processing unit 110 sets Qₙ equal to Q. At step 10400, the outphasing signal processing unit 110 shifts the bitmap image EB₁ down by Qₙ. If Q is not greater than zero, then at step 10450, the outphasing signal processing unit 110 sets Qₙ equal to −Q. At step 10500, the outphasing signal processing unit 110 shifts image EB₁ up by Qₙ.

At step 10550, the outphasing signal processing unit 110 determines whether the value of I is greater than zero. If I is greater than zero, then at step 10600, the outphasing signal processing unit 110 sets Iₙ equal to I. At step 10650, the outphasing signal processing unit 110 shifts the bitmap image B₁ right by Iₙ. If I is not greater than zero, then at step 10700, the outphasing signal processing unit 110 sets Iₙ equal to −I. At step 10750, the outphasing signal processing unit 110 shifts image B1 left by Iₙ. As an example, FIGS. 10B and 10C show the resulting bitmap data structure of shifted images.

At step 10800, the outphasing signal processing unit 110 performs a bitwise AND operation between the overlapped regions of the binary circle B₁ shown in FIG. 8D, and the binary circle B₂ shown in FIG. 8C to find the row and column number (I₁, Q₁) of the foreground point in the resultant image. At step 10850, the outphasing signal processing unit 110 determines values for S₂ (I₂, Q₂) where I₂ be equal to I-I₁ and Q₂ to be equal to Q-Q₁. The process goes to 10900, and ends.

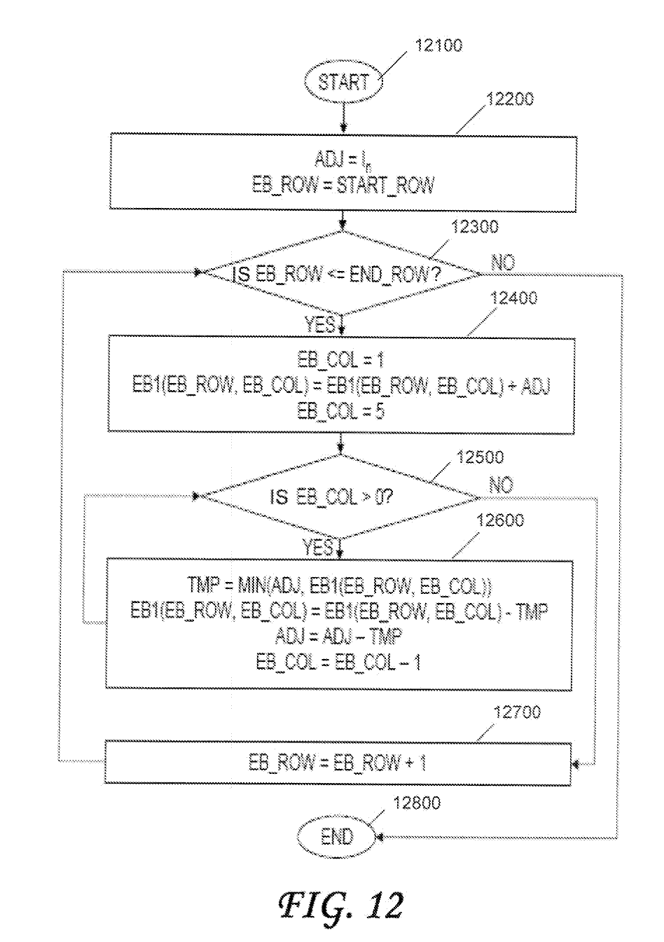

FIG. 12 shows an exemplary flowchart of a possible shift right operation using encoded bitmaps. The process begins at step 12100, and proceeds to step 12200 where the outphasing signal processing unit 100 sets value ADJ equal to Iₙ; and EB_ROW=START_ROW. At step 12300, the outphasing signal processing unit 110 determines whether the current bitmap row EB is less than or equal to the end row, as shown by EB_ROW<=END_ROW. If the current bitmap row EB is not less than or equal to the end row, then the process goes to step 12800, and ends. If the current bitmap row EB is less than or equal to the end row, then at step 12400, the outphasing signal processing unit 110 sets the current bitmap column to one EB_COL=1) and performs the operation EB1 (EB_ROW, EB_COL)=EB1 (EB_ROW, EB_COL)+ADJ; then sets EB_COL=5.

At step 12500, the outphasing signal processing unit 110 determines whether the cell value of the current column to be greater than zero. If the cell value of the current column is not greater than zero, the process goes to step 12700 and the row number is incremented by one (EB_ROW=EB_ROW+1). The process then returns to step 12300. If the outphasing signal processing unit 110 determines that the cell value of the current column is greater than zero, at step 12600, the outphasing signal processing unit 110 determines TMP=MIN (ADJ, EB1 (EB_ROW, EB_COL)); then sets EB1 (EB_ROW, EB_COL)=EB1 (EB_ROW, EB_COL)−TMP; ADJ=ADJ−TMP; and EB_COL=EB_COL+1. The process then returns to step 12500.

If at step 12300, the outphasing signal process unit 110 determines that the last row has been reached, then the process goes to step 12800 and ends.

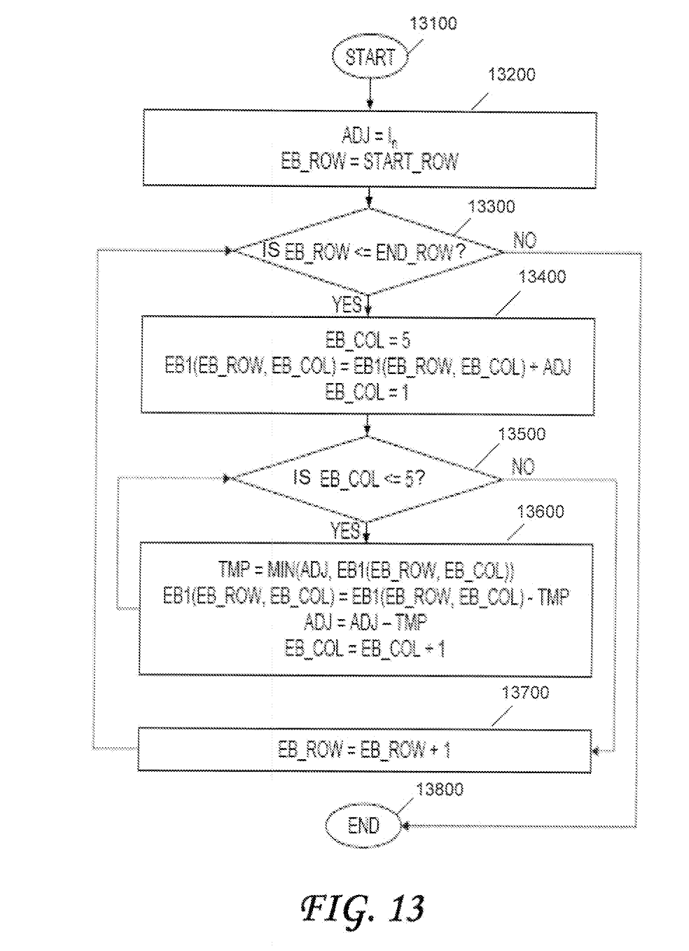

FIG. 13 is an exemplary flowchart of a possible shift left operation using encoded bitmaps. The process begins at step 13100, and proceeds to step 13200 where the outphasing signal processing unit 100 value sets value ADJ equal to Iₙ and EB_ROW=START_ROW. At step 13300, the outphasing signal processing unit 110 determines whether the current bitmap row EB is less than or equal to the end row, as shown by EB_ROW<=END_ROW. If the current bitmap row EB is not less than or equal to the end row, then the process goes to step 13800, and ends. If the current bitmap row EB is less than or equal to the end row, then at step 13400, the outphasing signal processing unit 110 sets the current bitmap column to five (EB_COL=5) and performs the operation EB1(EB_ROW, EB_COL)=EB1 (EB_ROW, EB_COL)+ADJ, and then resets the current bitmap column pointer to one (EB_COL=1).

At step 13500, the outphasing signal processing unit 110 determines whether the cell value of the current column EB_COL to be less than or equal to 5. If the cell value of the current column is not less than or equal to five, the process goes to step 13700 and the row number is incremented (EB_ROW=EB_ROW+1). The process then returns to step 13300. If the outphasing signal processing unit 110 determines that the cell value of the current column is less than or equal to 5, at step 13600, the outphasing signal processing unit 110 determines TMP=MIN (ADJ, EB1 (EB_ROW, EB_COL)); EB1 (EB_ROW, EB_COL)=EB1 (EB_ROW, EB_COL)−TMP; ADJ =ADJ−TMP; and EB_COL=EB_COL+1. The process then returns to step 13500.

If at step 13300, the outphasing signal process unit 110 determines that the last row has been reached, then the process goes to step 13800 and ends.

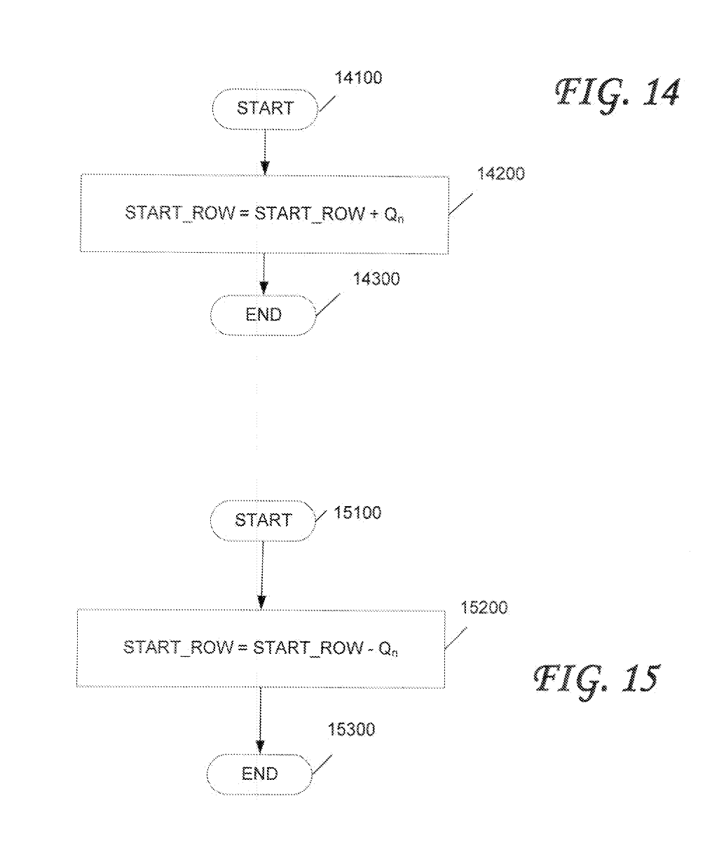

FIG. 14 shows an exemplary flowchart of a possible shift up operation for encoded bitmaps. The process begins at step 14100 and continues to step 14200 where the outphasing signal processing unit 110 sets the START_ROW=START_ROW+Qₙ. The process then goes to step 14300, and ends.

FIG. 13 shows an exemplary flowchart of a possible shift down operation for encoded bitmaps. The process begins at step 15100 and continues to step 15200 where the outphasing signal processing unit 110 sets the START_ROW=START_ROW−Qₙ. The process then goes to step 15300, and ends.

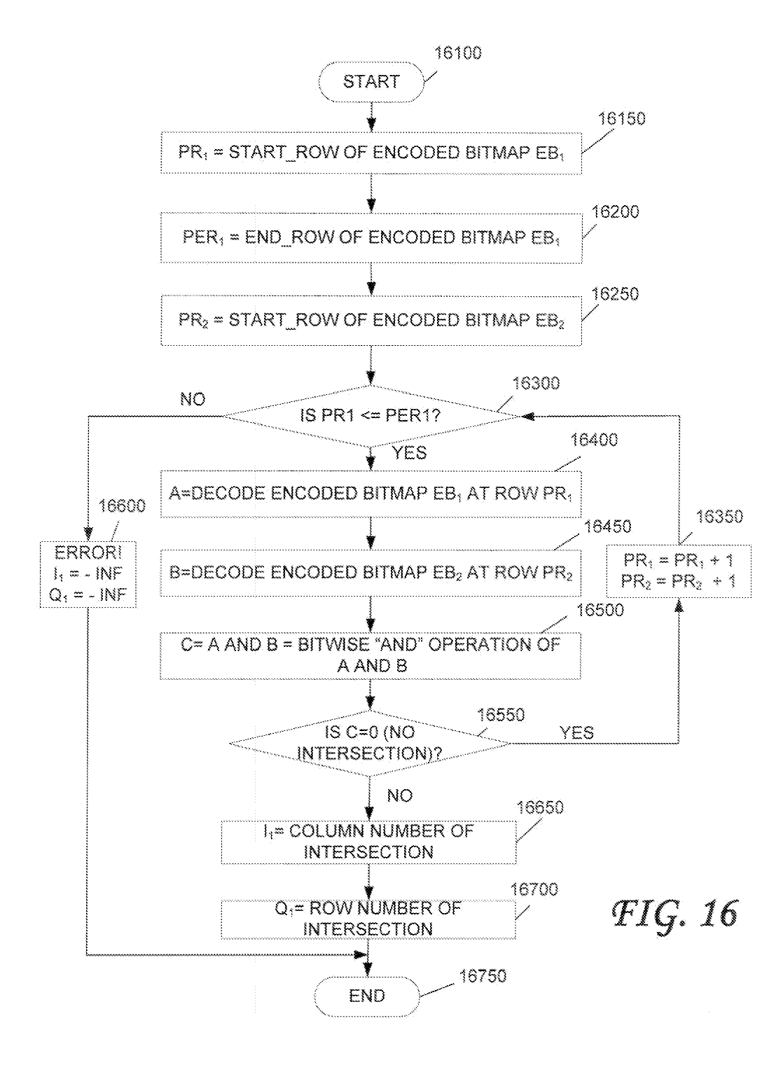

FIG. 16 is an exemplary flowchart illustrating the AND operation for encoded bitmap images from step 10800 in FIG. 10, as discussed above. The process begins at step 16100 and continues to step 16150 where the outphasing signal processing unit 110 sets PR₁ equal to the start row of bitmap EB₁. At step 16200, the outphasing signal processing unit 110 sets PER₁ equal to the end row of bitmap EB₁. At step 16250, the outphasing signal processing unit 110 sets PR₁ equal to the start row of bitmap EB₂. At step 16300, the outphasing signal processing unit 110 determines if the start row of encoded bitmap EB₁ is less than or equal to the end row. If the start row is not less than or equal to the end row, the process goes to step 16600 where an error signal is given. The process then goes to step 16750, and ends.

If the start row is not less than or equal to the end row, the process goes to step 16400 where A is set to be equal to the decoded value of the encoded bitmap EB₁ at row PR₁. At step 16400, B is set to be equal to the decoded value of the encoded bitmap EB₂ at row PR₂. At step 16500, C is set to be equal to the bitwise AND operation of the values of A and B from steps 16400 and 16450, respectfully.

The process continues to step 16550, where the outphasing signal processing unit 110 determines whether C equals zero, which would indicate that no intersection exists. If C equals zero, the process goes to step 16300 and the outphasing signal processing unit 110 increments the rows (PR₁ and PR₂) of the encoded bitmaps EB1 and EB2, and returns to step 16300. If C is not equal to zero, the process proceeds to step 16650 where the outphasing signal processing unit 110 sets I₁to equal the column number of the intersection. Then, at step 16700, the outphasing signal processing unit 110 sets Q₁ to equal the row number of the intersection. The process then goes to step 16750 and ends.

It is worth noting here that the techniques described in this present invention are directly suitable for parallel implementations by unfolding the loops and utilizing multiple processing elements. For single processor implementations further improvements can be achieved by slightly modifying the flow of the algorithm to perform the “AND” operation on a raw by raw basis and existing the loop when finding a first foreground point so as to increase the sequential processing speed. This alternative technique can be used with both the un-encoded and the encoded bitmaps. Any setting of the circles radius values (R₁ and R₂) that guarantees at least one intersection point to occur can be used. Additional modifications to the algorithm implementations can be made to suit specific hardware platforms.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. In other words, there may be multiple instances of the outphasing signal processing unit 110 in FIGS. 1 and 5, each processing the content in various possible ways. It does not necessarily need to be one system used by all end users. Accordingly, the appended claims and their legal equivalents should only define the invention, rather than any specific examples given.

We claim:

1. A method for generating outphased signals, comprising:
determining bitmap representations of two binary circles;
storing the bitmap representations of the two binary circles;
generating two constant-amplitude signals from an original signal using bitmap overlapping of the stored bitmap representations, wherein the vector sum of the two constant-amplitude signals equals the original signal; and
outputting the two constant-amplitude signals for use in an electronic device.

2. The method of claim 1, further comprising:
multiplying the original signal by a desired resolution;
determining an overlapped region of the two binary circles;
shifting one of the binary circles at least one of left, right, up and down; and
performing a bitwise AND operation of the two binary circles to create a resultant bitmap image.

3. The method of claim 2, storing at least one of the bitmap representations of the two constant-amplitude signals and the resultant bitmap image.

4. The method of claim 1, wherein the bitmap representations are encoded.

5. The method of claim 4, further comprising:
multiplying the original signal by a desired resolution;
determining an overlapped region of the two binary circles;
shifting one of the binary circles at least one of left, right, up and down; and
performing a bitwise AND operation of the two binary circles to create a resultant bitmap image.

6. The method of claim 5, storing the bitmap data structure of the encoded bitmap.

7. The method of claim 1, wherein the electronic device is a power amplifier.

8. An apparatus that generates outphased signals, comprising:
a bitmap storage unit; and
an outphasing signal processing unit that determines bitmap representations of two binary circles, stores the bitmap representations of the two binary circles in the bitmap storage unit, generates two constant-amplitude signals from an original signal using bitmap overlapping of the stored bitmap representations, wherein the vector sum of the two constant-amplitude signals equals the original signal, and outputs the two constant-amplitude signals for use in an electronic device.

9. The apparatus of claim 8, wherein the outphasing signal processing unit multiplies the original signal by a desired resolution, determines an overlapped region of the two binary circles, shifts one of the binary circles at least one of left, right, up and down, and performs a bitwise AND operation of the two binary circles to create a resultant bitmap image.

10. The apparatus of claim 8, wherein the outphasing signal processing unit stores at least one of the bitmap representations of the two constant-amplitude signals and the resultant bitmap image.

11. The apparatus of claim 8, wherein the bitmap representations are encoded.

12. The apparatus of claim 11, wherein the outphasing signal processing unit multiplies the original signal by a desired resolution, determines an overlapped region of the two binary circles, shifts one of the binary circles at least one of left, right, up and down, and performs a bitwise AND operation of the two binary circles to create a resultant bitmap image.

13. The apparatus of claim 12, wherein the outphasing signal processing unit stores the bitmap data structure of the encoded bitmap in the bitmap storage unit.

14. The apparatus of claim 8, wherein the electronic device is a power amplifier.

15. An electronic device that generates outphased signals, comprising:
a bitmap storage unit; and
an outphasing signal processing unit that determines bitmap representations of two binary circles, stores the bitmap representations of the two binary circles in the bitmap storage unit, generates two constant-amplitude signals from an original signal using bitmap overlapping of the stored bitmap representations, wherein the vector sum of the two constant-amplitude signals equals the original signal, and outputs the two constant-amplitude signals.

16. The electronic device of claim 15, wherein the outphasing signal processing unit multiplies the original signal by a desired resolution, determines an overlapped region of the two binary circles, shifts one of the binary circles at least one of left, right, up and down, and performs a bitwise AND operation of the two binary circles to create a resultant bitmap image.

17. The electronic device of claim 15, wherein the outphasing signal processing unit stores at least one of the bitmap representations of the two constant-amplitude signals and the resultant bitmap image.

18. The electronic device of claim 15, wherein the bitmap representations are encoded.

19. The electronic device of claim 18, wherein the outphasing signal processing unit multiplies the original signal by a desired resolution, determines an overlapped region of the two binary circles, shifts one of the binary circles at least one of left, right, up and down, and performs a bitwise AND operation of the two binary circles to create a resultant bitmap image.

20. The electronic device of claim 19, wherein the outphasing signal processing unit stores the bitmap data structure of the encoded bitmap in the bitmap storage unit.
